(19) United States
(12) Patent Application Publication
(10) Pub. No.: US 2026/0331774 A1
(43) Pub. Date: Oct. 22, 2026

(54) FEED NETWORK, ANTENNA APPARATUS, ACTIVE ANTENNA UNIT, AND COMMUNICATION DEVICE

(71) Applicant: HUAWEI TECHNOLOGIES CO., LTD., Shenzhen (CN)

(72) Inventors: Xianghua Li, Shenzhen (CN); Guanxi Zhang, Shanghai (CN); Bijun Zhang, Shanghai (CN); Xiaolai Li, Shanghai (CN)

(73) Assignee: HUAWEI TECHNOLOGIES CO., LTD., Shenzhen (CN)

(21) Appl. No.: 19/705,882

(22) Filed: Jun. 12, 2026

Related U.S. Application Data
(63) Continuation of application No. PCT/CN2024/133052, filed on Nov. 19, 2024.

(30) Foreign Application Priority Data
Dec. 15, 2023 (CN) 202311742921.0

(51) Int. Cl. H01Q 5/50; H01Q 1/38; H01Q 3/36

(52) U.S. Cl. CPC H01Q 5/50; H01Q 1/38; H01Q 3/36

(57) ABSTRACT

Embodiments of this application provide a feed network, an antenna apparatus, an active antenna unit, and a communication device. The feed network optically controls the phase state of a phase shifter without using a control line, allowing the feed network that includes the phase shifter to use an inverted microstrip structure, thereby reducing the insertion loss between the radio frequency channel and the antenna.

### CROSS-REFERENCE TO RELATED APPLICATIONS

This application is a continuation of International Application No. PCT/CN2024/133052, filed on Nov. 19, 2024, which claims priority to Chinese Patent Application No. 202311742921.0, filed on Dec. 15, 2023. The disclosures of the aforementioned applications are hereby incorporated by reference in their entireties.

### TECHNICAL FIELD

The present invention relates to the field of communications technologies, and in particular, to a feed network, an antenna apparatus, an active antenna unit, and a communication device.

### BACKGROUND

With the development of fifth generation mobile communication technology (5G technology), active antenna units (AAUs) have gradually become mainstream base station devices. An AAU generally includes a digital intermediate frequency processing unit (DIF), a radio frequency channel, and an antenna, where the radio frequency channel and the antenna are connected through a feed network. To improve the antenna signal coverage and user experience data rates, the antenna aperture of the AAU is expanded, for example, from 0.5 m×1 m to 0.5 m×1.5 m. In addition, the quantity of antennas connected to each radio frequency channel in the AAU has increased. Consequently, the antenna beam transmitted by each individual antenna is narrowed, reducing the coverage area.

Due to this, to ensure that the antenna beams can cover all users, the antenna beams need to be able to scan, meaning that the direction of the antenna beam is adjustable. Therefore, a phase shifter needs to be incorporated into the feed network of the AAU. By adjusting the phase state of the phase shifter, the direction of the antenna beam can be controlled.

However, normally, the feed network uses a standard microstrip structure. As shown in FIG. 1, the feed network includes a dielectric substrate, a metal film, and a metal bottom plate, with the dielectric substrate disposed between the metal film and the metal bottom plate. When a radio frequency signal is transmitted between the metal film and the metal bottom plate, the signal experiences loss as it passes through the dielectric substrate, resulting in a relatively high insertion loss between the radio frequency channel and the antenna.

### SUMMARY

Embodiments of this specification provide a feed network, an antenna apparatus, an active antenna unit, and a communication device. The feed network optically controls the phase state of a phase shifter, allowing the feed network that includes the phase shifter to use an inverted microstrip structure, thereby reducing the insertion loss between the radio frequency channel and the antenna.

According to a first aspect, an embodiment of this specification provides a feed network. The feed network includes a dielectric substrate, a metal film, a metal bottom plate, and a phase shifter;
the dielectric substrate includes a first surface, the metal film and the phase shifter are disposed on the first surface; and the metal film is configured to electrically connect an input end of a radio frequency channel to the phase shifter and electrically connect the phase shifter to an antenna element;
the phase shifter is configured to adjust a phase of a radio frequency signal, and each phase shifter includes at least one photosensitive component, also known as a photosensor; and the at least one photosensitive component is configured to control a phase state of the phase shifter based on received light; and
the metal bottom plate is disposed opposite to and spaced apart from the first surface, the metal bottom plate is configured to be grounded, the metal bottom plate includes at least one through hole provided opposite to the at least one photosensitive component, and the through hole is configured to expose the corresponding photosensitive component.

In the feed network, the photosensitive component is used in the phase shifter to optically control the phase state of the phase shifter, allowing the feed network that includes the phase shifter to use an inverted microstrip structure, thereby reducing the insertion loss between the radio frequency channel and the antenna element.

With reference to the first aspect, in a possible embodiment, the photosensitive component is a PIN photodiode.

With reference to the first aspect, in a possible embodiment, the phase shifter is a switched-line phase shifter, a loaded-line phase shifter, a hybrid phase shifter, a high-pass/low-pass phase shifter, or a vector modulator phase shifter.

With reference to the first aspect, in a possible embodiment, the feed network further includes a first controller, a first drive circuit, and at least one light source; the at least one light source is respectively disposed opposite to the at least one through hole, so that light emitted by the light source is received by the photosensitive component via the through hole; the first controller is electrically connected to the first drive circuit, and the first controller is configured to control the first drive circuit; and the first drive circuit is configured to drive the at least one light source to be turned on or turned off.

In the feed network, the light source is controlled to be turned on or turned off, to control a state of the photosensitive component, to optically control the phase state of the phase shifter, thereby implementing controlling the phase shifter.

With reference to the first aspect, in a possible embodiment, the photosensitive component is a photosensitive varactor diode or a series connection of a varactor diode and a photodiode.

With reference to the first aspect, in a possible embodiment, the phase shifter is a loaded-line phase shifter, a hybrid phase shifter, or a high-pass/low-pass phase shifter.

With reference to the first aspect, in a possible embodiment, the feed network further includes a second controller, a second drive circuit, and at least one light source; the at least one light source is respectively disposed opposite to the at least one through hole, so that light emitted by the light source is received by the photosensitive component via the through hole; the second controller is electrically connected to the drive circuit, and the second controller is configured to control the second drive circuit; and the second drive circuit is configured to control light intensity of the at least one light source.

In the feed network, light intensity of the light source is controlled, to control a capacitance of the photosensitive varactor diode or an output current of the photodiode, to control the phase state of the phase shifter, thereby optically controlling the phase shifter.

With reference to the first aspect, in a possible embodiment, the feed network further includes a circuit board, the circuit board is disposed opposite to and spaced apart from a surface of the metal bottom plate facing away from the dielectric substrate, the at least one light source is fastened on the circuit board at a position opposite to the corresponding through hole, and the circuit board is configured to electrically connect the controller and the drive circuit and electrically connect the drive circuit and the at least one light source.

With reference to the first aspect, in a possible embodiment, the feed network further includes a metal pillar, one end of the metal pillar is electrically connected to a ground terminal of the phase shifter, and the other end of the metal pillar is electrically connected to the metal bottom plate.

According to a second aspect, an embodiment of this disclosure further provides a feed network. The feed network includes a dielectric substrate, a metal film, a metal bottom plate, a phase shifter, and at least one phase shifter control circuit;
the dielectric substrate includes a first surface, the metal film and the phase shifter are disposed on the first surface; and the metal film is configured to electrically connect an input end of a radio frequency channel to the phase shifter and electrically connect the phase shifter to an antenna element;
the phase shifter is configured to adjust a phase of a radio frequency signal; and the phase shifter includes at least one switch component;
the phase shifter control circuit includes a photodiode, the phase shifter control circuit is configured to drive, based on a state of the photodiode, the switch component to be turned on or turned off, and the switch component is configured to control a phase state of the phase shifter; and
the metal bottom plate is disposed opposite to and spaced apart from the first surface are, the metal bottom plate is configured to be grounded, the metal bottom plate includes at least one through hole, the at least one through hole is respectively provided opposite to the photodiode in the at least one phase shifter control circuit, and the through hole is configured to expose the corresponding photodiode.

In the feed network, the photosensitive component is used in the phase shifter control circuit to optically control the phase state of the phase shifter without using a control line, allowing the feed network that includes the phase shifter to use an inverted microstrip structure, thereby reducing the insertion loss between the radio frequency channel and the antenna element.

With reference to the second aspect, in a possible embodiment, the photosensitive component is a PIN photodiode.

With reference to the second aspect, in a possible embodiment, the phase shifter is a switched-line phase shifter, a loaded-line phase shifter, a hybrid phase shifter, a high-pass/low-pass phase shifter, or a vector modulator phase shifter.

With reference to the second aspect, in a possible embodiment, the feed network further includes a controller, a drive circuit, and at least one light source; the at least one light source is respectively disposed opposite to the at least one through hole, so that light emitted by the light source is received by the photosensitive component via the through hole; the controller is electrically connected to the drive circuit, and the controller is configured to control the drive circuit; and the drive circuit is configured to drive the at least one light source to be turned on or turned off.

With reference to the second aspect, in a possible embodiment, the feed network further includes a circuit board, the circuit board is disposed opposite to and spaced apart from a surface of the metal bottom plate facing away from the dielectric substrate, the at least one light source is fastened on the circuit board at a position opposite to the corresponding through hole, and the circuit board is configured to electrically connect the controller and the drive circuit and electrically connect the drive circuit and the at least one light source.

With reference to the second aspect, in a possible embodiment, the feed network further includes a metal pillar, one end of the metal pillar is electrically connected to a ground terminal of the phase shifter, and the other end of the metal pillar is electrically connected to the metal bottom plate.

With reference to the second aspect, in a possible embodiment, the phase shifter control circuit further includes a first resistor, a second resistor, a third resistor, a fourth resistor, a fifth resistor, a first switching transistor, and a first inductor; and
a control terminal of the first switching transistor is grounded via the first resistor; the control terminal of the first switching transistor is further electrically connected to an anode of the photodiode, and a cathode of the photodiode is electrically connected to a first power supply via the second resistor; a first terminal of the first switching transistor is electrically connected to the first power supply via the third resistor; a second terminal of the first switching transistor is grounded via the fourth resistor; and the second terminal of the first switching transistor is electrically connected to one end of the first inductor via the fifth resistor, and the other end of the first inductor is configured to be electrically connected to the switch component.

In the feed network, the phase shifter control circuit is provided to optically control the phase shifter.

With reference to the second aspect, in a possible embodiment, the phase shifter control circuit further includes a sixth resistor, a seventh resistor, an eighth resistor, a first operational amplifier, a ninth resistor, a first electrically controlled switch, and a second inductor; the first operational amplifier includes a first input terminal, a second input terminal, and an output terminal; and the first electrically controlled switch includes a first terminal, a second terminal, a third terminal, and a fourth terminal;
a cathode of the photodiode is electrically connected to a second power supply via the sixth resistor; an anode of the photodiode is grounded; the seventh resistor and the eighth resistor are connected in series between the second power supply and ground; the first input terminal of the first operational amplifier is electrically connected to a common node of the cathode of the photodiode and the sixth resistor; the second input terminal of the first operational amplifier is electrically connected to a common node of the eighth resistor and the seventh resistor; the output terminal of the first operational amplifier is electrically connected to the second power supply via the ninth resistor, and is electrically connected to the first terminal of the first electrically controlled switch; the second terminal of the first electrically controlled switch is electrically connected to a third power supply; the third terminal of the first electrically controlled switch is electrically connected to a fourth power supply; the fourth terminal of the first electrically controlled switch is electrically connected to one end of the second inductor; and the other end of the second inductor is electrically connected to the switch component;
when the photodiode is conducting, the output terminal of the first operational amplifier outputs a first level signal; and when the first terminal of the first electrically controlled switch receives the first level signal, the fourth terminal of the first electrically controlled switch outputs the third power supply, so that the switch component is in a first operating state;
when the photodiode is cut off, the output terminal of the first operational amplifier outputs a second level signal; and when the first terminal of the first electrically controlled switch receives the second level signal, the fourth terminal of the first electrically controlled switch outputs the fourth power supply, so that the switch component is in a second operating state; and
the first operating state is on or forward-biased, and the second operating state is off or reverse-biased; or the first operating state is off or reverse-biased, and the second operating state is on or forward-biased.

In the feed network, the phase shifter control circuit is provided to optically control the phase shifter.

With reference to the second aspect, in a possible embodiment, the phase shifter control circuit further includes a tenth resistor, a third photodiode, an eleventh resistor, a second switching transistor, a second electrically controlled switch, and a third inductor; and the second electrically controlled switch includes a first terminal, a second terminal, a third terminal, and a fourth terminal;
a cathode of the photodiode is electrically connected to a fifth power supply via the tenth resistor; and an anode of the photodiode is grounded;
a control terminal of the second switching transistor is electrically connected to a common node of the tenth resistor and the photodiode, and a first terminal of the second switching transistor is electrically connected to the fifth power supply via the eleventh resistor; a second terminal of the second switching transistor is grounded, and the first terminal of the second electrically controlled switch is electrically connected to the first terminal of the second switching transistor, and the second terminal of the second electrically controlled switch is electrically connected to a sixth power supply; the third terminal of the second electrically controlled switch is electrically connected to a seventh power supply; the fourth terminal of the second electrically controlled switch is electrically connected to one end of the third inductor; and the other end of the third inductor is electrically connected to the switch component;
when the photodiode is conducting, the first terminal of the second switching transistor outputs a third level signal; and when the first terminal of the second electrically controlled switch receives the third level signal, the fourth terminal of the second electrically controlled switch outputs the sixth power supply, so that the switch component is in a first operating state;
when the photodiode is cut off, the first terminal of the second switching transistor outputs a fourth level signal; and when the first terminal of the second electrically controlled switch receives the fourth level signal, the fourth terminal of the second electrically controlled switch outputs the seventh power supply, so that the switch component is in a second operating state; and
the first operating state is on or forward-biased, and the second operating state is off or reverse-biased; or the first operating state is off or reverse-biased, and the second operating state is on or forward-biased.

In the feed network, the phase shifter control circuit is provided to optically control the phase shifter.

According to a third aspect, an embodiment of this specification further provides an antenna apparatus. The antenna apparatus includes an antenna, the feed network according to the first aspect or any embodiment of the first aspect, and an antenna array.

According to a fourth aspect, an embodiment of this specification further provides an active antenna unit. The active antenna unit includes a radio frequency channel, an antenna array, and the feed network according to the first aspect or any embodiment of the first aspect.

According to a fifth aspect, an embodiment of this specification further provides a communication device. The communication device includes the antenna apparatus according to the third aspect or any embodiment of the third aspect or the active antenna unit according to the fourth aspect or any embodiment of the fourth aspect.

### BRIEF DESCRIPTION OF DRAWINGS

FIG. 1 is a cross-sectional view of a structure of a feed network using a microstrip according to an embodiment of this specification;

FIG. 2 is a cross-sectional view of a structure of a feed network using an inverted microstrip according to an embodiment of this specification;

FIG. 3 is a cross-sectional view of a structure of a feed network including a phase shifter according to an embodiment of this specification;

FIG. 4 is a diagram of a structure of a communication device according to an embodiment of this specification;

FIG. 5A is a schematic of a circuit of an AAU according to an embodiment of this specification;

FIG. 5B is a schematic of another circuit of an AAU according to an embodiment of this specification;

FIG. 6A to FIG. 6P are schematics of circuits of some phase shifters according to embodiments of this specification;

FIG. 7 is a schematic of a circuit of a phase shifter module according to an embodiment of this specification;

FIG. 8A to FIG. 8C are schematics of circuits of a plurality of phase shifter control circuits according to embodiments of this specification;

FIG. 9A is a cross-sectional view of a structure of a feed network according to an embodiment of this specification;

FIG. 9B is a bottom view of a structure of a dielectric substrate according to an embodiment of this specification;

FIG. 9C is a bottom view of a structure of a metal bottom plate according to an embodiment of this specification;

FIG. 9D is a cross-sectional view of a structure of another feed network according to an embodiment of this specification;

FIG. 9E is a cross-sectional view of a structure of another feed network according to an embodiment of this specification;

FIG. 10A is a cross-sectional view of a structure of a phase shifter module according to an embodiment of this specification; and

FIG. 10B is a cross-sectional view of a structure of a phase shifter module according to an embodiment of this specification.

### DESCRIPTION OF EMBODIMENTS

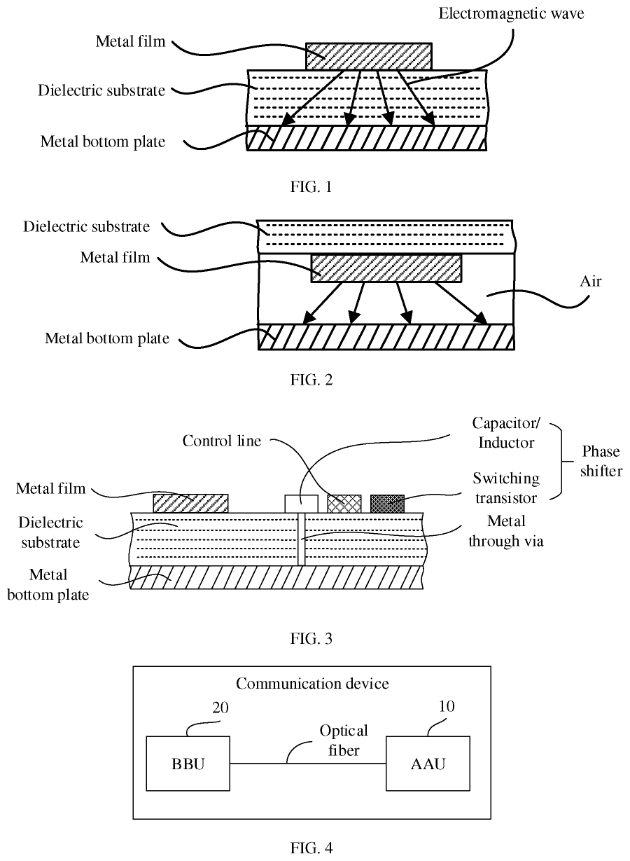

A feed network may use an inverted microstrip structure to reduce the insertion loss of the feed network between the radio frequency channel and the antenna. FIG. 2 is a cross-sectional view of a feed network using an inverted microstrip. In the inverted microstrip, air exists between a metal film and a metal bottom plate, and during transmission of a radio frequency signal between the metal film and the metal bottom plate, a loss generated when the radio frequency signal passes through the air is lower than a loss generated when the radio frequency signal passes through a dielectric substrate in the standard microstrip in FIG. 1. Therefore, the insertion loss can be reduced in the feed network using the inverted microstrip structure.

However, in the prior art, feed networks that include phase shifters all use standard microstrips. As shown in FIG. 3, in a sectional view of the feed network, the metal film in the feed network, and a capacitor, an inductor, a switching transistor, and the like in a phase shifter are all disposed on a surface of the dielectric substrate facing away from the metal bottom plate. The switching transistor in the phase shifter needs to be regulated. Therefore, the switching transistor needs to be electrically connected to a control module or a baseband unit through a control line, so that the baseband unit can control a phase state of the phase shifter, to regulate a beam direction. The control line also needs to be disposed on the surface of the dielectric substrate facing away from the metal bottom plate, and is on a same side of the dielectric substrate as the metal film. In addition, a part of the capacitor or the inductor in the phase shifter needs to be connected to the metal bottom plate through a metal through via to be grounded. The metal through via needs to pass through the dielectric substrate. Therefore, only the standard microstrip can be used in the feed network that includes the phase shifter.

The baseband unit sends a beam direction (also referred to as a beam orientation) to the control module, and the control module determines a phase state of each phase shifter based on a received beam direction, to drive the phase state of each phase shifter through the control line. Alternatively, the baseband unit determines the phase state of each phase shifter based on a required beam direction, to control the phase state of each phase shifter through the control line.

The metal film is configured to electrically connect the radio frequency channel, the phase shifter, and the antenna. The switching transistor may be a PIN (positive intrinsic negative) diode (also referred to as a PIN), and is configured to adjust the phase state of the phase shifter. The control line is electrically connected to the switching transistor, and is configured to drive the switching transistor to be turned on and turned off.

The phase state of the phase shifter is a change amount of a phase of a radio frequency signal before and after the radio frequency signal passes through the phase shifter, and the switching transistor controls a bias of a diode in the phase shifter or a capacitance of a varactor diode in the phase shifter, to adjust the phase of the radio frequency signal.

To reduce the insertion loss of the feed network that includes the phase shifter, a feed network provided in this embodiment of this disclosure optically controls the phase state of the phase shifter, and a circuit board in which the phase shifter is located may not need to be electrically connected, through the control line, to a circuit board that includes the control module and the baseband unit, so that the feed network that includes the phase shifter can use the inverted microstrip structure, to reduce the insertion loss between the radio frequency channel and the antenna. To implement an optically controlled phase shifter, embodiments of this disclosure provide the following four solutions.

Solution 1: Replace a PIN diode in the phase shifter with a photosensitive PIN diode, and optically control conduction and cut-off of the photosensitive PIN diode, to control the phase state of the phase shifter.

Solution 2: Replace a varactor diode in the phase shifter with a photosensitive varactor diode, and optically control a capacitance of the photosensitive varactor diode, to control the phase state of the phase shifter.

Solution 3: Replace a varactor diode in the phase shifter with a series connection of a varactor diode and a photodiode, and optically control an output current of the photodiode, to control a capacitance of the varactor diode, thereby controlling the phase state of the phase shifter.

Solution 4: The phase shifter that includes a PIN diode remains unchanged, and an optically controlled phase shifter control circuit is added. The phase shifter control circuit includes a photosensitive component, such as a photodiode. The phase shifter control circuit is configured to drive conduction and cut-off of the PIN diode based on whether the photodiode receives light.

It can be learned that the foregoing phase shifters may not need the control line, and the phase state of the phase shifter may be optically controlled.

In the feed network of the inverted microstrip structure, the foregoing phase shifter, the phase shifter control circuit, and the metal film are disposed on a surface of the dielectric substrate opposite to the metal bottom plate, the metal film and the metal bottom plate are separated by air, and the radio frequency signal is transmitted through the air, to reduce the insertion loss of the feed network between the radio frequency channel and the antenna.

The following separately describes a communication device, an AAU, a feed network, a phase shifter, a phase shifter module, and the like in embodiments of this specification.

FIG. 4 is a diagram of a structure of a communication device according to an embodiment of this specification. The communication device may be a base station.

For example, the communication device is a base station. The base station may be used in a plurality of wireless communication systems, for example, code division multiple access (CDMA), time division multiple access (TDMA), frequency division multiple access (FDMA), orthogonal frequency division multiple access (OFDMA), single carrier frequency division multiple access (single carrier FDMA, SC-FDMA), and another system. Terms “system” and “network” are interchangeable. The CDMA system may implement wireless technologies such as universal terrestrial radio access (UTRA) and CDMA2000. The UTRA may include a wideband CDMA (WCDMA) technology and another variant technology of the CDMA. The CDMA2000 may cover the interim standard (IS) 2000(IS-2000 ), the IS-95 standard, and the IS-856 standard. The TDMA system may implement wireless technologies such as a global system for mobile communications (GSM). The OFDMA system may implement wireless technologies such as evolved universal terrestrial radio access (evolved UTRA, E-UTRA), ultra mobile broadband (ultra mobile broadband, UMB), IEEE 802.11 (Wi-Fi), IEEE 802.16 (WiMAX), IEEE 802.20, and Flash OFDMA. The UTRA corresponds to a UMTS, and the E-UTRA corresponds to an evolved version of the UMTS. A new version of UMTS that uses E-UTRA is used in long term evolution (LTE) and various versions evolved based on LTE in 3GPP. A 5G communication system and new radio (NR) are next generation communication systems in development. In addition, the communication system may be further used in a future-oriented communication technology to which the technical solutions provided in embodiments of this specification may be applied.

Therefore, the base station provided in this specification may include devices that provide a base station function in a 2G network, a 3G network, a 4G network, a 5G network, and a wireless local area network. Devices that provide a base station function in the 2G network include a base transceiver station (BTS) and a base station controller (BSC). Devices that provide a base station function in the 3G network include a NodeB and a radio network controller (RNC). Devices that provide a base station function in the 4G network include an evolved NodeB (eNB). A device that provides a base station function in the wireless local area network (WLAN) is an access point (AP). Devices that provide a base station function in the 5G communication system include an eNB, a new radio NodeB (gNB), a central unit (CU), a distributed unit, a new radio controller, and the like. Typically, the base station in which the phase shifter provided in this disclosure is used may be a high-power macro base station in the 5G communication system, such as a millimeter-wave macro base station or a Sub-6G macro base station.

The communication device may include an active antenna unit (AAU) 10 and a baseband unit (BBU) 20. The AAU 10 and the BBU 20 may be connected through an optical fiber. The BBU 20 is configured to send a digital signal to the AAU 10 through the optical fiber. The AAU 10 is configured to: convert the digital signal from the BBU 20 into an analog signal, perform processing such as amplification and filtering on the analog signal, and then transmit a processed analog signal through an antenna.

The AAU 10 is further configured to: receive a signal through the antenna, perform processing such as filtering and amplification on the signal, convert a processed analog signal into a digital signal, and send the digital signal to the BBU 20. The BBU 20 is further configured to process a received digital signal.

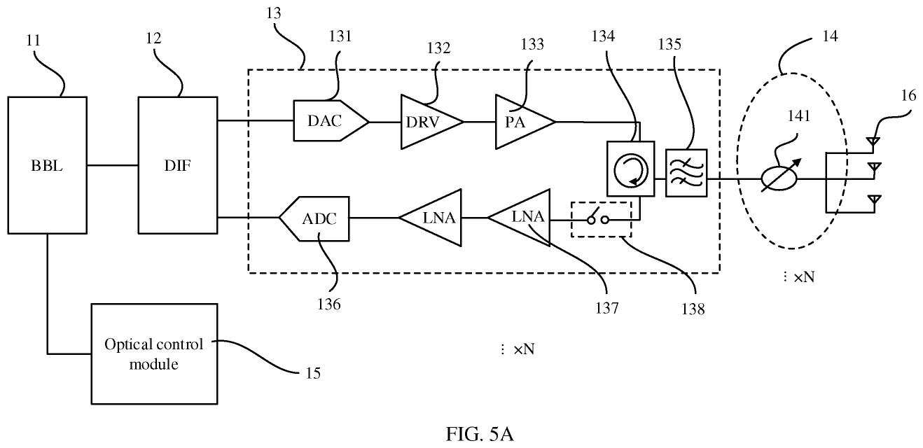

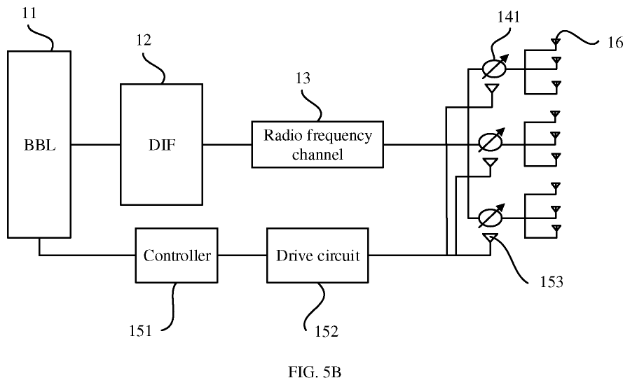

FIG. 5A is a schematic of a circuit of an AAU 10. The AAU 10 includes but is not limited to a baseband low (BBL) 11, a digital intermediate frequency processing unit (DIF) 12, N radio frequency channels 13, N feed networks 14, an optical control module 15, and an antenna array. The antenna array includes at least one antenna element 16, and N is a positive integer not less than 1. The BBL 11 is communicatively connected to the DIF 12. The DIF 12 is electrically connected to the N radio frequency channels 13. Each radio frequency channel 13 is electrically connected to one feed network 14. Each feed network 14 is electrically connected to one or more antenna elements 16. The BBL 11 may further be communicatively connected to the optical control module 15.

Not limited to the AAU 10 shown in FIG. 5A, the AAU 10 may include more or fewer components.

In some embodiments, a BBU may include two parts: baseband high (baseband high, BBH) and baseband low (BBL). The BBH and the BBL respectively implement different functions of baseband processing. The BBU 20 in FIG. 4 may be the BBH. The BBL may be disposed in the AAU 10. It should be understood that the AAU 10 may alternatively not include the BBL 11.

In some other embodiments, the AAU 10 may not include the BBL 11, and the DIF 12 may be communicatively connected to the BBU 20 in FIG. 4.

The DIF 12 is configured to perform digital intermediate frequency processing, including but not limited to upsampling, clipping processing, and the like.

Each radio frequency channel 13 may include a part or all of components such as a digital-to-analog converter (DAC) 131, a driver amplifier (DRV) 132, at least one power amplifier (PA) 133, a circulator 134, a filter 135, an analog-to-digital converter (ADC) 136, at least one low noise amplifier (LNA) 137, and a switch unit 138.

In an embodiment, each feed network 14 includes but is not limited to at least one phase shifter 141 or includes a phase shifter 141 and a phase shifter control circuit. An output end of the radio frequency channel 13 may be electrically connected to an input port of one or more phase shifters 141 through a microstrip, and an output port of the phase shifter may be electrically connected to one or more antenna elements 16 through a microstrip. The phase shifter 141 is configured to adjust a phase of a radio frequency signal that passes through the phase shifter 141; and phases of a plurality of phase shifters 141 are adjusted, to adjust a beam direction of the antenna array. A phase of each phase shifter 141 may be determined based on a beam direction to be adjusted to and a position of an antenna element 16 connected to the phase shifter 141.

When the feed network 14 includes a phase shifter control circuit, the phase shifter control circuit is configured to control a bias state of a diode or a capacitance of a varactor diode in the phase shifter based on a state of a photodiode included in the phase shifter control circuit, to adjust the phase of the radio frequency signal that passes through the phase shifter.

In some embodiments, the optical control module 15 may be communicatively connected to the BBL 11, or communicatively connected to the BBU 20, and is configured to control a phase state of the phase shifter 141.

To clearly represent a structure of the optical control module 15 and a correspondence between a light source in the optical control module 15 and a phase shifter, a schematic of a circuit of an AAU 10 in FIG. 5B is described by using one radio frequency channel as an example.

The optical control module 15 includes a controller 151, a drive circuit 152, and one or more light sources 153. The controller 151 is electrically connected to the BBL 11 or the BBU 20, to implement communication between the controller 151 and the BBL 11 or the BBU 20. The controller 151 is connected to the drive circuit 152, and is configured to send a control signal to the drive circuit 152, the drive circuit 152 is configured to drive, based on the control signal, the light source 153 to be turned on or turned off, and/or control the light intensity of the emitted light.

For the solution 1 and the solution 4, the BBL 11 or the BBU 20 is configured to send first information to the optical control module 15, and the optical control module 15 controls, based on the first information through the drive circuit 152, at least one light source 153 that is electrically connected to the drive circuit 152 to be tuned on or turned off. In this case, the first information may indicate a state of the at least one light source 153. A state of the light source 153 includes an on state and an off state. Alternatively, the first information indicates a beam direction, and the controller 151 is further configured to determine a state of each light source 153 based on a received beam direction.

For the solution 2 and the solution 3, the BBL 11 or the BBU 20 is configured to send second information to the optical control module 15, and the optical control module 15 controls, based on the second information through the drive circuit 152, the light intensity of at least one light source that is electrically connected to the drive circuit 152. In this case, the second information may indicate the light intensity of the at least one light source 153. Alternatively, the second information indicates a beam direction, and the controller 151 is further configured to determine the light intensity of each light source 153 based on a received beam direction.

The light source 153 is configured to provide a light source for a photosensitive component (such as a photosensitive PIN diode, a photosensitive varactor diode, or a photodiode) in the phase shifter 141. Alternatively, the light source 153 is configured to provide a light source for a photosensitive component (such as a photodiode) in the phase shifter control circuit.

The light source 153 may be an LED, a laser, or the like. An operating band of the light source 153 may be visible light, near-infrared, or far-infrared.

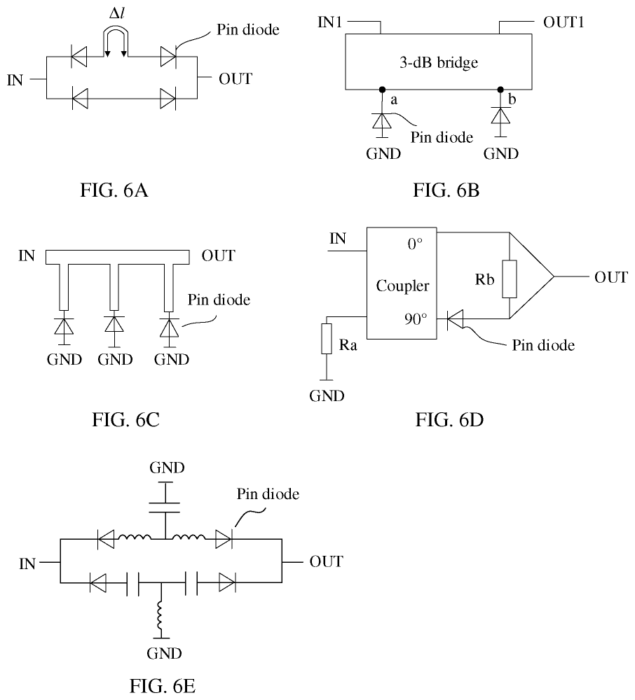

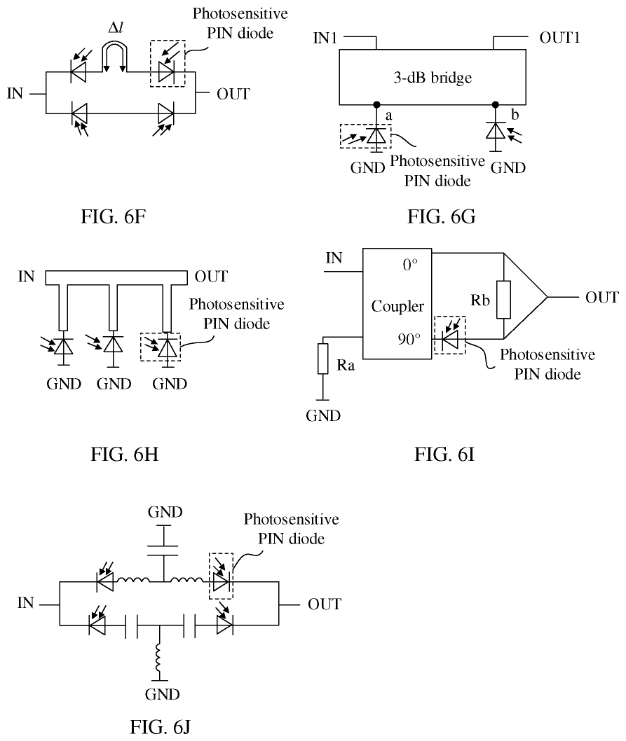

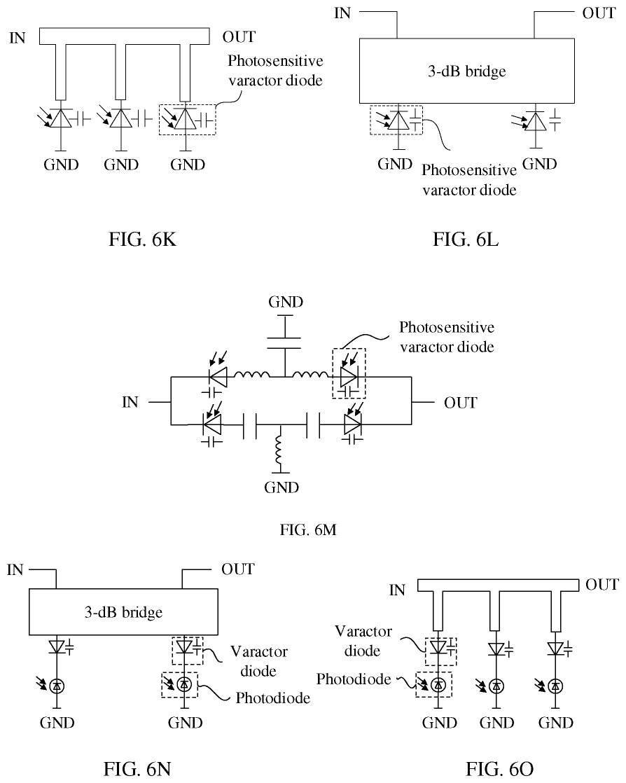

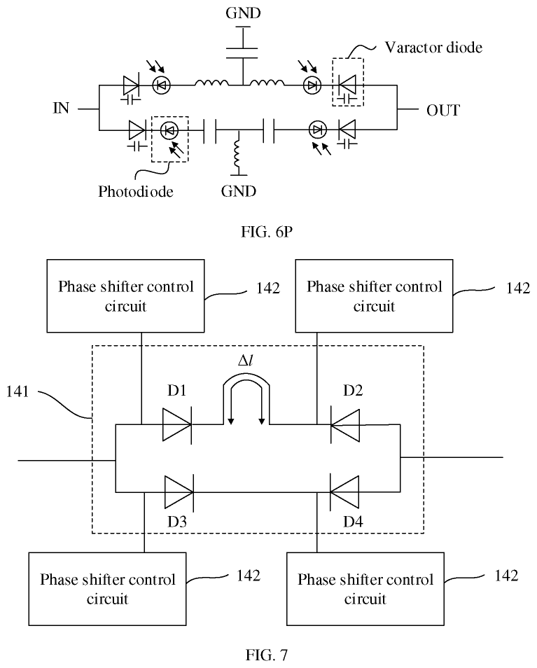

The following describes the foregoing phase shifter 141 with reference to FIG. 6A to FIG. 6P.

The phase shifter 141 may include one or a combination of a plurality of a switched-line phase shifter, a hybrid phase shifter, a loaded-line phase shifter, a vector modulator phase shifter, and a high-pass/low-pass phase shifter, and the following uses an example in which one type of phase shifter is included for description. It should be understood that, not limited to the foregoing enumerated phase shifters, the phase shifter 141 may alternatively be a phase shifter of another type.

Schematics of circuits of phase shifters 141 that do not include a photosensitive component according to embodiments of this disclosure are specifically described with reference to FIG. 6A to FIG. 6E.

FIG. 6A is a schematic of a circuit of a phase shifter 141, which is a switch-type phase shifter.

The phase shifter 141 includes a first branch and a second branch. Each of the first branch and the second branch includes two PIN diodes. The input terminal IN of the phase shifter 141 is electrically connected to the radio frequency channel 13 through a connection line, and an anode of the PIN diode is electrically connected to an anode of the other PIN diode. The output terminal OUT of the phase shifter 141 is electrically connected to the antenna element 16 through a connection line. The two PIN diodes in the first branch are conducting or are cut off simultaneously, the two PIN diodes in the second branch are conducting or are cut off simultaneously, the PIN diode in the first branch and the PIN diode in the second branch are not conducting simultaneously, and the radio frequency signal passes through the first branch or the second branch. A length of a connection line between the two PIN diodes in the first branch is Al longer than a length of a connection line between the two PIN diodes in the second branch. Al may be 5 millimeters (mm), 10 mm, 15 mm, or the like. Therefore, there is a difference between a phase of a radio frequency signal passing through the first branch and a phase of a radio frequency signal passing through the second branch, so that the phase shifter 141 regulates the phase of the radio frequency signal.

FIG. 6B is a schematic of a circuit of a phase shifter 141, which is a hybrid phase shifter.

The hybrid phase shifter includes but is not limited to a 3-dB bridge and two PIN diodes. The 3-dB bridge includes an input port IN1 (namely, the input port of the phase shifter 141), an output port OUT1 (namely, the output port of the phase shifter 141), a coupled port a, and an isolated port b. The input port IN1 of the 3-dB bridge is electrically connected to the radio frequency channel 13 through a connection line. The output port OUT1 of the 3-dB bridge is electrically connected to the antenna element 16 through a connection line. The coupled port a of the 3-dB bridge is electrically connected to a cathode of one PIN diode, and an anode of the PIN diode is grounded. The isolated port b of the 3-dB bridge is electrically connected to a cathode of the other PIN diode, and an anode of the PIN diode is grounded.

The 3-dB bridge may alternatively be replaced with a 5-dB bridge, a 20-dB bridge, or the like.

FIG. 6C is a schematic of a circuit of a phase shifter 141, which is a loaded-line phase shifter.

The loaded-line phase shifter includes a main path and three branches. The main path may include a resistor. One end (namely, the input port IN of the phase shifter 141) of the main path is electrically connected to the radio frequency channel 13 through a connection line, and the other end (namely, the output port OUT of the phase shifter 141) of the main path is electrically connected to the antenna element 16 through a connection line. Each branch includes but is not limited to one or more PIN diodes, an anode of the PIN diode is grounded or suspended, and a cathode of the PIN diode is electrically connected to the main path.

In FIG. 6C, three branches are used as an example for description. The loaded-line phase shifter may include more or fewer branches.

FIG. 6D is a schematic of a circuit of a phase shifter 141, which is a vector modulator phase shifter.

The vector modulator phase shifter includes a 90° coupler, a grounding resistor Ra, a branch resistor Rb, and a PIN diode. The 90° coupler includes an input port IN, a ground port, a 0° port, and a 90°port. The input port IN of the 90° coupler is electrically connected to the radio frequency channel 13 through a connection line, and the radio frequency signal is input from the input port IN of the coupler. The ground terminal is grounded (GND) via the grounding resistor Ra. The 0° port is electrically connected to the antenna element 16 through a connection line. The 90° port is electrically connected to a cathode of the PIN diode, and an anode of the PIN diode is electrically connected to the antenna element 16 through a connection line. The branch resistor Rb is electrically connected between the 0° port and the anode of the PIN diode. When the PIN diode is conducting, a difference between a phase of a radio frequency signal output from the 0° port and a phase of a radio frequency signal output from the 90° port is π/2. In other words, it is implemented that the vector modulator phase shifter (namely, the phase shifter 141) regulates the phase of the radio frequency signal.

The 90° coupler may alternatively be replaced with a 45° coupler, a 180° coupler, or the like.

FIG. 6E is a schematic of a circuit of a phase shifter 141, which is a high-pass/low-pass phase shifter.

The high-pass/low-pass phase shifter includes two branches. One branch includes two PIN diodes that are electrically connected reversely, two inductors are connected in series between the two PIN diodes, a common node of the two inductors is electrically connected to one end of a capacitor, and the other end of the capacitor is grounded. The other branch includes two PIN diodes that are connected reversely, two capacitors are connected in series between the two PIN diodes, a common node of the two capacitors is electrically connected to one end of an inductor, and the other end of the inductor is grounded.

When the PIN diode is forward-biased, the PIN diode is conducting. On the contrary, when the PIN diode is reverse-biased or an anode of the PIN diode is grounded, the PIN diode is cut off. Therefore, in some embodiments, conduction of the PIN diode may alternatively be replaced with a forward bias (also referred to as FB for short) of the PIN diode, and cut-off of the PIN diode may alternatively be replaced with a reverse bias (also referred to as RB for short) of the PIN diode.

The output port of the phase shifter 141 is electrically connected to the antenna element 16 through the connection line, and may be electrically connected to one antenna element 16, or may be electrically connected to a plurality of antenna elements 16. When the output port of the phase shifter 141 is electrically connected to the plurality of antenna elements 16, the output port of the phase shifter 141 may alternatively be connected to the plurality of antenna elements 16 through a power division network.

In some other embodiments, the PIN diodes in the phase shifters shown in FIG. 6B, FIG. 6C, and FIG. 6E may alternatively be replaced with varactor diodes. When the PIN diodes in the phase shifters are replaced with varactor diodes, capacitances of these varactor diodes are controlled, to control the phase of the radio frequency signal that passes through the phase shifter.

FIG. 6F to FIG. 6J show examples of phase shifters obtained by replacing the PIN diodes in the phase shifters shown in FIG. 6A to FIG. 6E with photosensitive PIN diodes. Connection relationships of the circuits of the phase shifters shown in FIG. 6F to FIG. 6J are the same as those shown in FIG. 6A to FIG. 6E, and a connection relationship of the photosensitive PIN diode is the same as that of the PIN diode. For details, refer to related descriptions in FIG. 6A to FIG. 6E, and details are not described herein again. In this case, the optical control module 15 controls a light source corresponding to the photosensitive PIN diode in the phase shifter to be turned on or turned off, to control conduction and cut-off of the photosensitive PIN diode, thereby controlling the phase state of the phase shifter.

FIG. 6K to FIG. 6M show examples of phase shifters obtained by replacing the PIN diodes in the phase shifters shown in FIG. 6B, FIG. 6C, and FIG. 6E with photosensitive varactor diodes. Connection relationships of the circuits of the phase shifters shown in FIG. 6K to FIG. 6M are the same as those shown in FIG. 6B, FIG. 6C, and FIG. 6E, and a connection relationship of the photosensitive varactor diode is the same as that of the PIN diode. For details, refer to related descriptions in FIG. 6B, FIG. 6C, and FIG. 6E, and details are not described herein again. In this case, the optical control module 15 controls light intensity of a light source corresponding to the photosensitive varactor diode in the phase shifter, to control a capacitance of the photosensitive varactor diode, thereby controlling the phase state of the phase shifter.

FIG. 6N to FIG. 6P show examples of phase shifters obtained by replacing the PIN diode in the phase shifters shown in FIG. 6B, FIG. 6C, and FIG. 6E with a series connection of a varactor diode and a photodiode. Connection relationships of the circuits of the phase shifters shown in FIG. 6N to FIG. 6P are the same as those shown in FIG. 6B, FIG. 6C, and FIG. 6E, and a connection relationship of a series connection of the varactor diode and the photodiode is the same as that of the PIN diode. For details, refer to related descriptions in FIG. 6B, FIG. 6C, and FIG. 6E, and details are not described herein again. In this case, the optical control module 15 controls light intensity of a light source corresponding to the photodiode in the phase shifter, to control a capacitance of the photosensitive varactor diode that is connected in series to the photodiode, thereby controlling the phase state of the phase shifter.

When the phase shifter 141 is the phase shifter shown in FIG. 6A to FIG. 6E, the feed network 14 further includes the phase shifter control circuit 142.

The following uses the phase shifter shown in FIG. 6A as an example to describe, with reference to FIG. 7, a schematic of a circuit of a phase shifter module according to an embodiment of this specification. The phase shifter module may include any one of the phase shifters shown in FIG. 6A to FIG. 6E and the phase shifter control circuit 142.

The phase shifter module may include one phase shifter 141 and a plurality of phase shifter control circuits 142. In some embodiments, one phase shifter control circuit 142 is electrically connected to an anode of one PIN diode, and is configured to drive conduction or cut-off of one PIN diode in the phase shifter. In some other embodiments, one phase shifter control circuit 142 is electrically connected to a plurality of PIN diodes that are simultaneously conducting or cut off during operation, and is configured to drive conduction or cut-off of the plurality of PIN diodes. It should be understood that, when the PIN diode is forward-biased, the PIN diode is conducting. On the contrary, when the PIN diode is not biased, for example, when the PIN diode is grounded, or when the PIN diode is reverse-biased, the PIN diode is cut off. The PIN diode is configured to control the phase state of the phase shifter 141. The phase state of the phase shifter 141 varies with a state of the PIN diode.

For example, in the phase shifter 141 shown in FIG. 7, the two PIN diodes included in the first branch are a first PIN diode D1 and a second PIN diode D2, and the two PIN diodes included in the second branch are a third PIN diode D3 and a fourth PIN diode D4.

The phase shifter control circuit 142 includes but is not limited to one or more photodiodes. The photodiode is conducting when receiving light, and is cut off when not receiving light. The phase shifter control circuit 142 controls, based on conduction and cut-off of the photodiode, conduction and cut-off of a PIN diode electrically connected to the phase shifter control circuit 142. For example, when the photodiode in the phase shifter control circuit 142 receives light, the PIN diode electrically connected to the phase shifter control circuit 142 is conducting. On the contrary, when the photodiode in the phase shifter control circuit 142 does not receive light, the PIN diode electrically connected to the phase shifter control circuit 142 is cut off.

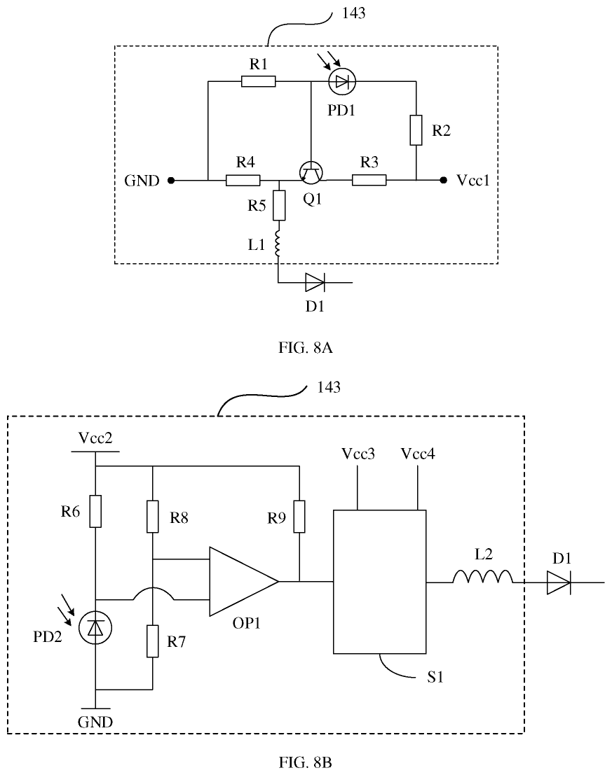

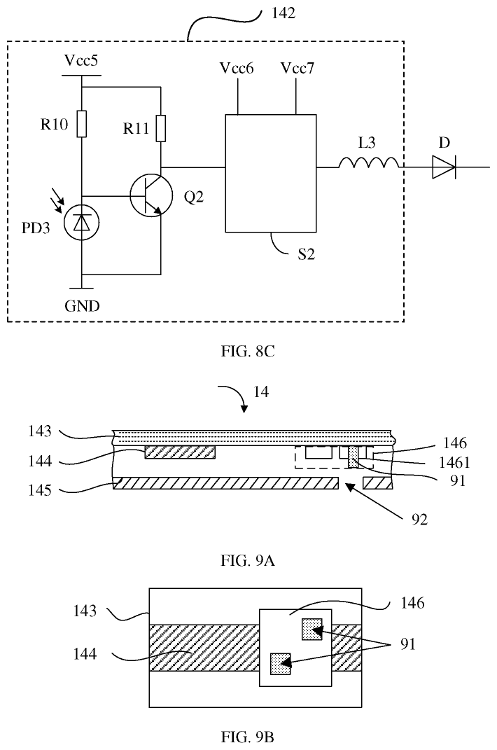

With reference to FIG. 8A to FIG. 8C, the following describes schematics of circuits of a plurality of phase shifter control circuits 142 according to embodiments of this disclosure.

FIG. 8A is a schematic of a circuit of a phase shifter control circuit 142 according to an embodiment of this specification.

An example in which the phase shifter control circuit 142 is electrically connected to the first PIN diode D1 in FIG. 7 is used for description. The phase shifter control circuit 142 includes but is not limited to a first resistor R1, a second resistor R2, a third resistor R3, a fourth resistor R4, a fifth resistor R5, a first photodiode PD1, a first switching transistor Q1, and a first inductor L1.

A control terminal of the first switching transistor Q1 is grounded via the first resistor R1; the control terminal of the first switching transistor Q1 is further electrically connected to an anode of the first photodiode PD1, and a cathode of the first photodiode PD1 is electrically connected to a first power supply Vcc1 via the second resistor R2; a first terminal of the first switching transistor Q1 is electrically connected to the first power supply Vcc1 via the third resistor R3; a second terminal of the first switching transistor Q1 is grounded via the fourth resistor R4; and the second terminal of the first switching transistor Q1 is electrically connected to one end of the first inductor L1 via the fifth resistor R5, and the other end of the first inductor L1 is configured to be electrically connected to an anode of the first PIN diode D1.

In the phase shifter control circuit 142 shown in FIG. 8A, the fifth resistor R5 is not necessary, and the second terminal of the first switching transistor Q1 may be electrically connected to the anode of the first PIN diode D1 in the phase shifter 141 directly through the first inductor L1.

When the controller 151 controls, through the drive circuit 152, a light source 153 corresponding to the first photodiode PD1 to be turned on, the first photodiode PD1 receives light and is conducting, and the first switching transistor Q1 is turned on. In other words, the first terminal and the second terminal of the first switching transistor Q1 are connected, the second terminal of the first switching transistor Q1 outputs a high-level signal, and the first PIN diode D1 is conducting. On the contrary, when the controller 151 controls, through the drive circuit 152, the light source 153 corresponding to the first photodiode PD1 to be turned off, the first photodiode PD1 does not receive light and is cut off, the first switching transistor Q1 is turned off, the first terminal and the second terminal of the first switching transistor Q1 are disconnected, the second terminal of the first switching transistor Q1 outputs a low-level signal, and the first PIN diode D1 is cut off.

The foregoing uses an example in which the first switching transistor Q1 is an NPN switching transistor. In another embodiment, the first switching transistor Q1 may alternatively be a PNP switching transistor.

FIG. 8B is a schematic of another circuit of a phase shifter control circuit 142 according to an embodiment of this disclosure.

An example in which the phase shifter control circuit 142 is electrically connected to the first PIN diode D1 in FIG. 7 is used for description. The phase shifter control circuit 142 includes but is not limited to a sixth resistor R6, a second photodiode PD2, a seventh resistor R7, an eighth resistor R8, a first operational amplifier OP1, a ninth resistor R9, a first electrically controlled switch S1, and a second inductor L2. The first operational amplifier OP1 includes a first input terminal, a second input terminal, and an output terminal. The first electrically controlled switch S1 includes a first terminal, a second terminal, a third terminal, and a fourth terminal.

A cathode of the second photodiode PD2 is electrically connected to a second power supply Vcc2 via the sixth resistor R6; an anode of the second photodiode PD2 is grounded (GND); the seventh resistor R7 and the eighth resistor R8 are connected in series between the second power supply Vcc2 and ground (GND); the first input terminal of the first operational amplifier OP1 is electrically connected to a common node of the cathode of the second photodiode PD2 and the sixth resistor R6; the second input terminal of the first operational amplifier OP1 is electrically connected to a common node of the eighth resistor R8 and the seventh resistor R7; the output terminal of the first operational amplifier OP1 is electrically connected to the second power supply Vcc2 via the ninth resistor R9 and is electrically connected to the first terminal of the first electrically controlled switch S1; the second terminal of the first electrically controlled switch S1 is electrically connected to a third power supply Vcc3; the third terminal of the first electrically controlled switch S1 is electrically connected to a fourth power supply Vcc4; the fourth terminal of the first electrically controlled switch S1 is electrically connected to one end of the second inductor L2; and the other end of the second inductor L2 is electrically connected to the anode of the first PIN diode D1.

The first electrically controlled switch S1 is configured to select, based on a signal input by the first terminal of the first electrically controlled switch S1, an electrical signal to be input to the fourth terminal from an electrical signal electrically connected to the third terminal and an electrical signal electrically connected to the fourth terminal, that is, select the third power supply Vcc3 electrically connected to the second terminal or the fourth power supply Vcc4 electrically connected to the third terminal.

When the controller 151 controls, through the drive circuit 152, a light source 153 corresponding to the second photodiode PD2 to be turned on, the second photodiode PD2 is conducting. When the second photodiode PD2 is conducting, the output terminal of the first operational amplifier OP1 outputs a first level signal; and when the first terminal of the first electrically controlled switch S1 inputs the first level signal, the fourth terminal of the first electrically controlled switch S1 outputs the third power supply Vcc3, so that the first PIN diode D1 is in a first operating state.

When the controller 151 controls, through the drive circuit 152, the light source 153 corresponding to the second photodiode PD2 to be turned off, the second photodiode PD2 is cut off. When the second photodiode PD2 is cut off, the output terminal of the first operational amplifier OP1 outputs a second level signal; and when the first terminal of the first electrically controlled switch S1 inputs the second level signal, the fourth terminal of the first electrically controlled switch S1 outputs the fourth power supply Vcc4, so that the first PIN diode D1 is in a second operating state.

For example, the first level signal is at a high level, the third power supply Vcc3 has a positive voltage, for example, 1 V, the first operating state is conducting or forward-biased, the second level signal is at a low level, for example, grounded (GND), the fourth power supply Vcc4 has a negative voltage, for example, −3 V, and the second operating state is off or reverse-biased.

For another example, the first level signal is at a ground level, for example, grounded (GND), the first operating state is off or reverse-biased, the second level signal has a high level, and the second operating state is conducting or forward-biased.

FIG. 8C is a schematic of another circuit of a phase shifter control circuit 142 according to an embodiment of this specification.

An example in which the phase shifter control circuit 142 is electrically connected to the first PIN diode D1 in FIG. 7 is used for description. The phase shifter control circuit 142 includes but is not limited to a fifth power supply Vcc5, a tenth resistor R10, a third photodiode PD3, an eleventh resistor R11, a second switching transistor Q2, a second electrically controlled switch S2, and a third inductor L3. The second electrically controlled switch S2 includes a first terminal, a second terminal, a third terminal, and a fourth terminal.

A cathode of the third photodiode PD3 is electrically connected to the fifth power supply Vcc5 via the tenth resistor R10; and an anode of the third photodiode PD3 is grounded (GND).

A control terminal of the second switching transistor Q2 is electrically connected to a common node of the tenth resistor R10 and the third photodiode PD3, and a first terminal of the second switching transistor Q2 is electrically connected to the fifth power supply via the eleventh resistor R11; a second terminal of the second switching transistor Q2 is grounded, the first terminal of the second electrically controlled switch S2 is electrically connected to the first terminal of the second switching transistor Q2, and the second terminal of the second electrically controlled switch S2 is electrically connected to the sixth power supply Vcc6; the third terminal of the second electrically controlled switch S2 is electrically connected to the seventh power supply Vcc7; the fourth terminal of the second electrically controlled switch S2 is electrically connected to one end of the third inductor L3; and the other end of the third inductor L3 is electrically connected to the anode of the first PIN diode D1.

The second electrically controlled switch S2 is configured to select, based on a signal input by the first terminal of the second electrically controlled switch S2, an electrical signal to be input to the fourth terminal from an electrical signal electrically connected to the third terminal and an electrical signal electrically connected to the fourth terminal, that is, select the sixth power supply Vcc6 electrically connected to the second terminal or the seventh power supply Vcc7 electrically connected to the third terminal.

When the controller 151 controls, through the drive circuit 152, a light source 153 corresponding to the third photodiode PD3 to be turned on, and when the third photodiode PD3 is conducting, the first terminal of the second switching transistor Q2 outputs a third level signal; and when the first terminal of the second electrically controlled switch S2 inputs the third level signal, the fourth terminal of the second electrically controlled switch S2 outputs the sixth power supply Vcc6, so that the first PIN diode D1 is in the first operating state.

When the controller 151 controls, through the drive circuit 152, the light source 153 corresponding to the third photodiode PD3 to be turned off, and when the third photodiode PD3 is cut off, the first terminal of the second switching transistor Q2 outputs a fourth level signal; and when the first terminal of the second electrically controlled switch S2 inputs the fourth level signal, the fourth terminal of the second electrically controlled switch S2 outputs the seventh power supply Vcc7, so that the first PIN diode D1 is in the second operating state.

For example, the third level signal is at a high level, the sixth power supply Vcc6 has a positive voltage, for example, 1 V, the first operating state is conducting or forward-biased, the fourth level signal is at a low level, for example, grounded (GND), the seventh power supply Vcc7 has a negative voltage, for example, −3 V, and the second operating state is off or reverse-biased.

For another example, the third level signal is at a ground level, for example, grounded (GND), the sixth power supply Vcc6 has a negative voltage, for example, −3 V, the first operating state is off or reverse-biased, the fourth level signal is at a high level, the seventh power supply Vcc7 has a positive voltage, for example, 1 V, and the second operating state is conducting or forward-biased.

The foregoing uses an example in which the second switching transistor Q2 is an NPN switching transistor. In another embodiment, the second switching transistor Q2 may alternatively be a PNP switching transistor.

The first power supply Vcc1, the second power supply Vcc2, and the fifth power supply Vcc5 may be 3 V or 5 V.

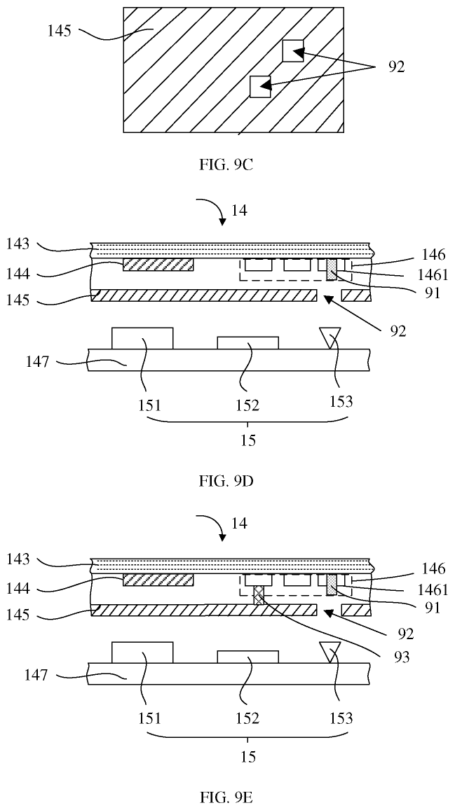

With reference to FIG. 9A to FIG. 9E, the following describes a structure of the feed network 14 according to an embodiment of this specification.

FIG. 9A is a cross-sectional view of the feed network 14. The feed network 14 may include a dielectric substrate 143, a metal film 144, a metal bottom plate 145, and a phase shifter module 146. The phase shifter module 146 includes at least one photosensitive component 1461.

For the solution 1 to the solution 3, the phase shifter module 146 includes the phase shifter 141 shown in FIG. 6F to FIG. 6P. The phase shifter 141 is configured to adjust the phase of the radio frequency signal. The photosensitive component 1461 is the photosensitive component included in the phase shifters 141 shown in FIG. 6F to FIG. 6P. The photosensitive component is configured to control the phase state of the phase shifter based on received light. The photosensitive component is the PIN photodiode in any one of the phase shifters 141 shown in FIG. 6F to FIG. 6J, or the photosensitive varactor diode in any one of the phase shifters 141 shown in FIG. 6K to FIG. 6M, or the photodiode in any one of the phase shifters 141 shown in FIG. 6N to FIG. 6P. For details, refer to the foregoing descriptions.

For the foregoing solution 4, the phase shifter module includes the phase shifter 141 and the phase shifter control circuit 142. The phase shifter 141 may be the phase shifter shown in FIG. 6A to FIG. 6E, and the phase shifter control circuit 142 may be the phase shifter control circuit shown in FIG. 8A to FIG. 8C. The phase shifter 141 is configured to adjust the phase of the radio frequency signal, and the phase shifter 141 includes at least one switch component. The photosensitive component 1461 is the photodiode in any one of the foregoing phase shifter control circuits 142 in FIG. 8A to FIG. 8C. The phase shifter control circuit 142 is configured to drive, based on the state of the photodiode, the switch component to be turned on or turned off, and the switch component is configured to control the phase state of the phase shifter 141.

The dielectric substrate 143 includes a first surface, and the metal film 144 and the phase shifter module 146 are disposed on the first surface.

The metal film 144 is configured to electrically connect the output end of the radio frequency channel 13 to the input port of the phase shifter 141, and electrically connect an output port of the phase shifter 141 to the antenna element 16.

As shown in FIG. 9B, a bottom view of the dielectric substrate 143 is described schematically. The metal film 144 is a part or all of the foregoing connection line. A section of the metal film 144 is electrically connected to an input end (namely, the input port of the phase shifter 141) of the radio frequency signal of the phase shifter module 146. After the phase shifter 141 is passed through, an output end (namely, the output port of the phase shifter 141) of the radio frequency signal of the phase shifter module 146 is electrically connected to another section of the metal film 144. A photosensitive part 91 of the photosensitive component in the phase shifter module 146 is exposed outside the phase shifter module 146, and is configured to receive an optical signal of the light source.

The metal bottom plate 145 is disposed opposite to and spaced apart from the first surface, the metal bottom plate 145 is configured to be grounded, the metal bottom plate 145 includes at least one through hole 92 provided opposite to each photosensitive component in the phase shifter module 146, and the through hole 92 is configured to expose a photosensitive part 91 of a corresponding photosensitive component 1461. One photosensitive component may correspond to one through hole 92, or a plurality of photosensitive components that are simultaneously turned on or turned off correspond to one through hole 92.

As shown in FIG. 9C, a bottom view of the metal bottom plate 145 is described schematically by using an example in which one photosensitive component corresponds to one through hole 92. A hole is provided in a part of the metal bottom plate 145 aligned with the photosensitive component, to form the through hole 92, where the through hole 92 is configured to expose the aligned photosensitive component, allowing an optical signal of the light source 153 to pass through.

The photosensitive component is PIN photodiodes, photosensitive varactor diodes, or photodiodes that are connected in series.

The photosensitive component is a PIN photodiode, a photosensitive varactor diode, or a series connection of a varactor diode and a photodiode.

FIG. 9D is a cross-sectional view of another feed network 14.

The feed network further includes a circuit board 147 and the optical control module 15. The circuit board 147 is disposed opposite to and spaced apart from a surface of the metal bottom plate 145 facing away from the dielectric substrate 143. The optical control module 15 may be disposed on the circuit board 147. Specifically, both the controller 151 and the drive circuit 152 in the optical control module 15 may be disposed on a surface of the circuit board 147 opposite to the metal bottom plate 145 or that faces away from the metal bottom plate 145, and each light source 153 is fastened on the circuit board at a position opposite to a corresponding through hole 92.

The circuit board 147 is configured for an electrical connection between the controller 151 and the drive circuit 152 and an electrical connection between the drive circuit 152 and the at least one light source 153. Specifically, a surface or inside of the circuit board 147 may be printed with a circuit, to implement the electrical connection between the controller 151, the drive circuit 152, and the light source 153.

In some embodiments, one photosensitive component corresponds to one through hole 92, and one through hole 92 corresponds to one light source 153.

In some other embodiments, a plurality of photosensitive components that are simultaneously turned on or turned off correspond to one through hole 92, and one through hole 92 corresponds to one light source 153.

In still some other embodiments, one photosensitive component corresponds to one through hole 92, and through holes 92 corresponding to a plurality of photosensitive components that are simultaneously turned on or turned off correspond to one light source 153.

FIG. 9E is a cross-sectional view of another feed network 14.

For the phase shifter module 146 that needs to be grounded, in addition to the components shown in FIG. 9D, the feed network 14 may further include a metal pillar 93, where one end of the metal pillar 93 is electrically connected to a ground terminal of the phase shifter 141, and the other end of the metal pillar 93 is electrically connected to the metal bottom plate 145.

An embodiment of this specification further provides the AAU 10. The AAU 10 may include the feed network 14 shown in FIG. 9A, FIG. 9D, or FIG. 9E.

In some embodiments, one or more of the DIF 12, the radio frequency channel 13, the BBL 11, and the like may further be disposed on the circuit board 147 in the feed networks 14 shown in FIG. 9D and FIG. 9E. For the DIF 12, the radio frequency channel 13, and the BBL 11, refer to related descriptions in FIG. 5A and FIG. 5B. Details are not described herein again. In this case, the circuit board 147 may also be referred to as a radio frequency board.

The following describes a structure of the phase shifter module 146 in embodiments of this specification.

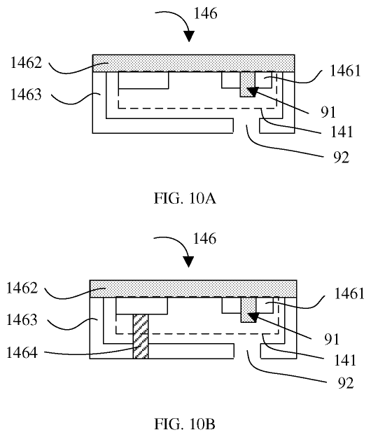

As shown in FIG. 10A, the phase shifter module 146 may include but is not limited to the phase shifter 141, a substrate 1462, and a packaging housing 1463. In some embodiments, the phase shifter module 146 may further include the phase shifter control circuit 142.

The phase shifter 141 may be disposed on a surface of the substrate 1462. The packaging housing 1463 is configured to package the phase shifter 141, and the packaging housing 1463 is further configured to isolate different photosensitive components in the phase shifter module 146, to prevent the photosensitive component from receiving an optical signal transmitted by a light source 153 that does not correspond to the photosensitive component. A material of the packaging housing 1463 may be an opaque insulation material.

The phase shifter module 146 may be soldered on the first surface of the dielectric substrate 143. Specifically, the substrate 1462 may include a metal through via and the like, to re-route the input port and the output port of the phase shifter 141 to a surface of the substrate 1462 facing away from the phase shifter 141, so that the phase shifter 141 is electrically connected to the metal film 144.

FIG. 10B is a diagram of another structure of the phase shifter module 146. When the phase shifter module 146 needs to be grounded, for example, when the phase shifter 141 or the phase shifter control circuit 142 needs to be grounded, or when a capacitor, an inductor, a PIN diode, a varactor diode, a photosensitive PIN diode, a photosensitive varactor diode, and the like (not shown in FIG. 10B) in the phase shifter module 146 needs to be grounded, in addition to the components in FIG. 10A, the phase shifter module 146 may further include a conductor pillar, where one end of the conductor pillar 1464 is electrically connected to the ground terminal of the phase shifter 141 and/or a ground terminal of the phase shifter control circuit 142, and the other end of the conductor pillar 1464 is exposed outside the packaging housing 1463 and is electrically connected to the metal bottom plate 145, to implement grounding of the phase shifter module 146.

In some embodiments, the phase shifter module 146 or the phase shifter 141 may be an independent passive component, and is soldered to the metal film 144.

In some other embodiments, to avoid grounding of the phase shifter 141, one or a combination of the switched-line phase shifter and the loaded-line phase shifter may be used. A grounding part of the loaded-line phase shifter may be changed into a section of microstrip.

In addition, an embodiment of this specification further provides an antenna apparatus. The antenna apparatus may include the feed network 14 shown in FIG. 9A, FIG. 9D, or FIG. 9E, and the antenna array that includes one or more antenna elements 16. For a connection relationship between the feed network 14 and the antenna element 16, refer to related descriptions in FIG. 5A, FIG. 5B, and the like. Details are not described herein again.

“Electrical connection” in this specification should be understood in a broad sense, and may include a direct electrical connection, or may be an indirect electrical connection. An “electrical connection” may be understood as physical contact and electrical conduction of components, and may also be understood as a form in which different components in a line structure are connected through physical lines that can transmit an electrical signal, such as a printed circuit board (PCB) copper foil or a conducting wire. An indirect connection may be understood as an electrical connection between two components through another component or circuit, or the like. A “communication connection” may mean electrical signal transmission, including a wireless communication connection and a wired communication connection. The wireless communication connection does not require a physical medium and does not belong to a connection relationship that limits construction of a product.

In this specification, the term “at least one” means one or more, and the term “a plurality of” means two or more.

In the specification, claims, and accompanying drawings of embodiments of this specification, the terms “first”, “second”, “third”, “fourth”, and the like (if existent) are intended to distinguish between similar objects but do not necessarily indicate a specific order or sequence.

The foregoing descriptions are merely optional embodiments of this specification, but are not intended to limit the protection scope of this disclosure. Any modification or replacement readily figured out by a person skilled in the art within the technical scope disclosed in this specification shall fall within the protection scope of this specification. Therefore, the protection scope of this disclosure shall be subject to the protection scope of the claims.

1. A feed network, comprising:
a dielectric substrate, a metal film, a metal bottom plate, and a phase shifter, wherein
the dielectric substrate comprises a surface,
the metal film and the phase shifter are disposed on the surface, and the metal film is configured to electrically connect an input end of a radio frequency channel to the phase shifter and electrically connect the phase shifter to an antenna element;
the phase shifter is configured to adjust a phase of a radio frequency signal and comprises a photosensor, wherein a phase state of the phase shifter varies according to light received by the photosensor; and
the metal bottom plate is disposed opposite to, and spaced apart from, the surface, is configured to be grounded, and comprises a through hole provided opposite to the photosensor component, wherein the through hole is configured to expose the photosensor.

2. The feed network according to claim 1, wherein the photosensor is a PIN photodiode.

3. The feed network according to claim 2, wherein the phase shifter is a switched-line phase shifter, a loaded-line phase shifter, a hybrid phase shifter, a high-pass/low-pass phase shifter, or a vector modulator phase shifter.

4. The feed network according to claim 1, further comprising a first controller, a first drive circuit, and a light source disposed opposite to the through hole, so that light emitted by the light source is received by the photosensor via the through hole;
the first controller is electrically connected to the first drive circuit, and
the first controller is configured to control the first drive circuit; and the first drive circuit is configured to drive the light source to be turned on or turned off.

5. The feed network according to claim 1, wherein the photosensor is a photosensitive varactor diode or a series connection of a varactor diode and a photodiode.

6. The feed network according to claim 5, wherein the phase shifter is a loaded-line phase shifter, a hybrid phase shifter, or a high-pass/low-pass phase shifter.

7. The feed network according to claim 1, wherein the feed network further comprises a second controller, a second drive circuit, and a second light source; the second light source is disposed opposite to a second through hole, so that light emitted by the second light source is received by a second photosensor via the second through hole;
the second controller is electrically connected to, a configured to control, the second drive circuit; and
the second drive circuit is configured to control a light intensity of the second light source.

8. The feed network according to claim 4, further comprising a circuit board disposed opposite to, and spaced apart from, a surface of the metal bottom plate facing away from the dielectric substrate, the light source is disposed on the circuit board at a position opposite to the through hole, and the circuit board is configured to electrically connect the first controller and the first drive circuit, and electrically connect the first drive circuit and the light source.

9. The feed network according to claim 1, further comprising a metal pillar, wherein one end of the metal pillar is electrically connected to a ground terminal of the phase shifter, and the other end of the metal pillar is electrically connected to the metal bottom plate.

10. A feed network, comprising:
a dielectric substrate, a metal film, a metal bottom plate, a phase shifter, and at least one phase shifter control circuit, wherein
the dielectric substrate comprises a surface,
the metal film and the phase shifter are disposed on the first surface, and the metal film is configured to electrically connect an input end of a radio frequency channel to the phase shifter and electrically connect the phase shifter to an antenna element;
the phase shifter is configured to adjust a phase of a radio frequency signal and comprises a switch and a photodiode, and is further configured to drive, based on a state of the photodiode, the switch to be turned on or turned off, and the switch is configured to control a phase state of the phase shifter; and
the metal bottom plate is disposed opposite to, and spaced apart from, the surface, is configured to be grounded, and comprises a through hole provided opposite to the photodiode in the at least one phase shifter control circuit, and the through hole is configured to expose the photodiode.

11. The feed network according to claim 10, wherein the phase shifter is a switched-line phase shifter, a loaded-line phase shifter, a hybrid phase shifter, a high-pass/low-pass phase shifter, or a vector modulator phase shifter.

12. The feed network according to claim 10, further comprising a circuit board disposed opposite to, and spaced apart from, a surface of the metal bottom plate facing away from the dielectric substrate, the light source is disposed on the circuit board at a position opposite to the through hole, and the circuit board is configured to electrically connect the first controller and the first drive circuit, and electrically connect the first drive circuit and the one light source.

13. The feed network according to claim 10, further comprising a metal pillar, wherein one end of the metal pillar is electrically connected to a ground terminal of the phase shifter, and the other end of the metal pillar is electrically connected to the metal bottom plate.

14. The feed network according to claim 10, wherein the phase shifter control circuit further comprises a first resistor, a second resistor, a third resistor, a fourth resistor, a fifth resistor, a first switching transistor, and a first inductor; and
a control terminal of the first switching transistor is grounded via the first resistor; the control terminal of the first switching transistor is further electrically connected to an anode of the photodiode, and a cathode of the photodiode is electrically connected to a first power supply via the second resistor; a first terminal of the first switching transistor is electrically connected to the first power supply via the third resistor; a second terminal of the first switching transistor is grounded via the fourth resistor; and the second terminal of the first switching transistor is electrically connected to one end of the first inductor via the fifth resistor, and the other end of the first inductor is configured to be electrically connected to the switch.

15. The feed network according to claim 10, wherein the phase shifter control circuit further comprises a sixth resistor, a seventh resistor, an eighth resistor, a first operational amplifier, a ninth resistor, a first electrically controlled switch, and a second inductor;
the first operational amplifier comprises a first input terminal, a second input terminal, and an output terminal; and the first electrically controlled switch comprises a first terminal, a second terminal, a third terminal, and a fourth terminal;
a cathode of the photodiode is electrically connected to a second power supply via the sixth resistor; an anode of the photodiode is grounded; the seventh resistor and the eighth resistor are connected in series between the second power supply and ground; the first input terminal of the first operational amplifier is electrically connected to a common node of the cathode of the photodiode and the sixth resistor; the second input terminal of the first operational amplifier is electrically connected to a common node of the eighth resistor and the seventh resistor; the output terminal of the first operational amplifier is electrically connected to the second power supply via the ninth resistor, and is electrically connected to the first terminal of the first electrically controlled switch; the second terminal of the first electrically controlled switch is electrically connected to a third power supply; the third terminal of the first electrically controlled switch is electrically connected to a fourth power supply; the fourth terminal of the first electrically controlled switch is electrically connected to one end of the second inductor; and the other end of the second inductor is electrically connected to the switch;
when the photodiode is conducting, the output terminal of the first operational amplifier outputs a first level signal; and when the first terminal of the first electrically controlled switch receives the first level signal, the fourth terminal of the first electrically controlled switch outputs the third power supply, so that the switch is in a first operating state;
when the photodiode is cut off, the output terminal of the first operational amplifier outputs a second level signal; and when the first terminal of the first electrically controlled switch receives the second level signal, the fourth terminal of the first electrically controlled switch outputs the fourth power supply, so that the switch is in a second operating state; and
the first operating state is on, and the second operating state is off; or the first operating state is off, and the second operating state is on.

16. The feed network according to claim 10, wherein the phase shifter control circuit further comprises a tenth resistor, a third photodiode, an eleventh resistor, a second switching transistor, a second electrically controlled switch, and a third inductor; and the second electrically controlled switch comprises a first terminal, a second terminal, a third terminal, and a fourth terminal;
a cathode of the photodiode is electrically connected to a fifth power supply via the tenth resistor; and an anode of the photodiode is grounded;
a control terminal of the second switching transistor is electrically connected to a common node of the tenth resistor and the photodiode, and a first terminal of the second switching transistor is electrically connected to the fifth power supply via the eleventh resistor; a second terminal of the second switching transistor is grounded, and the first terminal of the second electrically controlled switch is electrically connected to the first terminal of the second switching transistor, and the second terminal of the second electrically controlled switch is electrically connected to a sixth power supply; the third terminal of the second electrically controlled switch is electrically connected to a seventh power supply; the fourth terminal of the second electrically controlled switch is electrically connected to one end of the third inductor; and the other end of the third inductor is electrically connected to the switch;
when the photodiode is conducting, the first terminal of the second switching transistor outputs a third level signal; and when the first terminal of the second electrically controlled switch receives the third level signal, the fourth terminal of the second electrically controlled switch outputs the sixth power supply, so that the switch is in a first operating state;
when the photodiode is cut off, the first terminal of the second switching transistor outputs a fourth level signal; and when the first terminal of the second electrically controlled switch receives the fourth level signal, the fourth terminal of the second electrically controlled switch outputs the seventh power supply, so that the switch is in a second operating state; and
the first operating state is on, and the second operating state is off; or the first operating state is off, and the second operating state is on.

17. The feed network according to claim 1, wherein the photosensor is a photosensitive varactor diode.

18. The feed network according to claim 1, wherein the photosensor is a photodiode.

19. The feed network according to claim 1, wherein the light source is a LED.

20. The feed network according to claim 1, wherein the light source is a laser.
